(19) United States
(12) Patent Application Publication
(10) Pub. No.: US 2014/0019910 A1
(43) Pub. Date: Jan. 16, 2014

(54) TOUCH AND GESTURE INPUT-BASED CONTROL METHOD AND TERMINAL THEREFOR

(71) Applicant: Samsung Electronics Co., Ltd., Gyeonggi-do (KR)

(72) Inventors: Jinyong KIM, Seoul (KR); Jinyoung JEON, Seoul (KR); Jiyoung KANG, Gyeonggi-do (KR); Daesung KIM, Seoul (KR); Boyoung LEE, Seoul (KR)

(21) Appl. No.: 13/905,663

(22) Filed: May 30, 2013

(30) Foreign Application Priority Data
Jul. 16, 2012 (KR) 10-2012-0077021

(51) Int. Cl. G06F 3/0481

(52) U.S. Cl. CPC G06F 3/04817
USPC 715/810

(57) ABSTRACT

A touch and gesture input-based control method for a mobile terminal or handheld display is provided for facilitating the switching operation between for an object in response to a gesture input subsequent to a touch input. The method includes detecting a touch input; selecting at least one object corresponding to the touch input; detecting a gesture input; and performing switching corresponding to the gesture input in a state where the object is held at a position of the touch input. The invention permits paging through lists of documents or icons, etc., while retaining the display of the held object on the touch screen.

### CLAIM OF PRIORITY

This application claims the benefit under 35 U.S.C. §119(a) from a Korean patent application filed on Jul. 16, 2012 in the Korean Intellectual Property Office and assigned Serial No. 10-2012-0077021, the entire disclosure of which is hereby incorporated by reference in its entirety.

### BACKGROUND

1. Field of the Invention

The present disclosure relates to a touch and gesture input-based control method and portable terminal configured to perform the control method. More particularly, the present invention is related to a touch and gesture input-based control method for performing a switching operation utilizing a gesture input subsequent to a touch input.

2. Description of the Related Art

With the advance of communication technology and interactive display technology, smart electric devices, such as a smartphones and portable terminals such as tablets, etc., employ various input means to control the smartphone, such as touchscreen in order for the user to control the device more conveniently. Accordingly, studies are being conducted to recognize touch, motion, and gesture inputs with the assistance of sensors that can reduce the need to type out commands on relatively small display screen and quickly have commonly requested commands performed by the gesture inputs.

Technological advances have made it possible for the portable terminals to be configured to recognize various types of inputs, the user requirements for simplified terminal manipulation grow.

However, in spite of the capability of detecting various types of inputs, the current conventional terminals are limited in utilizing their input detection capability for controlling terminal operations, resulting in failure of meeting the needs of the users.

### SUMMARY

The present invention has been made in part in an effort to solve some of the drawbacks in art, and it is an object of the present invention to provide a touch and gesture input-based control method and terminal that perform an operation in response to a series of touch and gesture inputs.

It is another object of the present invention to provide a touch and gesture input-based control method and terminal that switches between objects in response to a gesture input subsequent to an ongoing touch input.

In accordance with an exemplary aspect of the present invention, a method for controlling a terminal preferably includes detecting a touch input; selecting at least one object corresponding to the touch input; detecting a gesture input; and performing a switching corresponding to the gesture input in a state where the object is held at a position of the touch input.

Preferably, the object that is held at a position of the touch input includes at least one of an icon, a text, an image, a file, a folder, a content of a web browser, a web address, and a web link.

Preferably, selecting at least one object corresponding to the touch input includes presenting the object in one of activated, enlarged, shrunk, shaded states.

Preferably, detecting a gesture input comprises sensing the gesture input in the state wherein the touch input is maintained.

Preferably, the switching corresponding to the gesture input comprises one of page switching, folder switching, tab switching, application switching, and task switching.

Preferably, performing includes holding the selected object corresponding to the touch input; and switching from among a plurality pages having at least one object in the state where the selected objected is held on the screen.

Preferably, performing may also include holding the selected object corresponding to the touch input; and switching from among higher and lower folders along a file path or between folders in a folder list.

Preferably, performing may also include holding the selected object corresponding to the touch input; and switching from among a plurality of taps provided by a web browser.

Preferably, the performing may also include holding the selected object corresponding to the touch input; and switching from among applications or tasks listed in a predetermined list or a list of currently running applications or tasks.

Preferably, switching from among applications or tasks includes displaying the selected object in a format arranged optimally for the application or task.

Preferably, the method according to the present invention further includes detecting a release of the touch input; and performing an operation corresponding to the release of the touch input for the selected object.

Preferably, according to the present invention, the operation corresponding to the release of the touch input is one of arranging the object at a position targeted by the touch input, executing a link of the selected object in a tab of the web browser, and pasting the object on and execution screen of the application or task.

In accordance with another exemplary aspect of the present invention, a terminal includes an input unit which detects touch and gesture inputs; a control unit configured for detecting selection of at least one object corresponding to the touch input on the touch-screen display and performing switching of the images shown on the display, corresponding to the gesture input, in a state where the object is held at a position of the touch input; and a display unit which displays a screen under the control of the control unit.

Preferably, the switching is one of page switching, folder switching, tab switching, application switching, and task switching.

Preferably, the control unit is configured to “hold” the selected object corresponding to the touch input and switches from among a plurality pages having at least one object in the state where the selected objected is held on the screen.

Preferably, the control unit is configured to “hold” the selected object corresponding to the touch input and switches from among higher and lower folders along a file path or between folders in a folder list.

Preferably, the control unit is configured to “hold” the selected object corresponding to the touch input and switches among a plurality of tabs provided by a web browser.

Preferably, the control unit is configured to “hold” the selected object corresponding to the touch input and switches among applications or tasks listed in a predetermined list or a list of currently running applications or tasks.

Preferably, the control unit is configured to control the display unit to display the selected object in a format arranged optimally for the application or task.

Preferably, the input unit detects a release of the touch input, and the control unit performs one of arranging the object at a position targeted by the touch input, executing a link of the selected object in a tab of the web browser, and pasting the object on an execution screen of the application or task.

In addition, a method for controlling a terminal preferably comprises: detecting a touch input by a sensor on a touchscreen display; detecting by a control unit of the terminal a selection of at least one object of a plurality of objects corresponding to the touch input on the touchscreen display; detecting a gesture input in a state wherein the touch input is maintained for at least a partial temporal overlap with detection of the gesture; and performing switching of a display of one or more of the plurality of objects other than the at least one object which is being held at a same position on the touchscreen display and corresponding to a direction associated with the gesture input in a state wherein the at least one object which is being held at a position of the touch input during detecting the gesture input on the touchscreen display.

### BRIEF DESCRIPTION OF THE DRAWINGS

FIG. 1 is a block diagram illustrating a configuration of the terminal according to an exemplary embodiment of the present invention;

FIG. 2 is a front view of a terminal equipped with a camera sensor and an infrared sensor.

FIG. 3 is a flowchart illustrating the method for controlling the terminal according to an exemplary embodiment of the present invention;

FIG. 4 is a diagram illustrating an exemplary touch input action for use in an exemplary embodiment of the present invention;

FIG. 5 is a diagram illustrating a combination of touch and gesture inputs for use in an exemplary embodiment of the present invention;

FIG. 6 is a diagram illustrating an exemplary page switching operation based on the combination of the touch and gesture inputs according to an exemplary embodiment of the present invention;

FIG. 7 is a diagram illustrating an exemplary folder switching operation based on the combination of the touch and gesture inputs according to an exemplary embodiment of the present invention;

FIG. 8 is a diagram illustrating an exemplary tab switching operation based on the combination of the touch and gesture inputs according to an exemplary embodiment of the present invention; and

FIG. 9 is a diagram illustrating an exemplary application or task switching operation based on the combination of the touch and gesture inputs according to an exemplary embodiment of the present invention.

### DETAILED DESCRIPTION

The present invention is suitable for many uses, one of which includes controlling a touch and gesture input-enabled terminal.

The present invention is applicable to all types of touch and gesture input-enabled terminals including a smartphone, a portable terminal, a mobile terminal, a Personal Digital Assistant (PDA), a Portable Multimedia Player (PMP), a laptop, a Note Pad, a Wibro terminal, a tablet PC, a smart TV, a smart refrigerator, and their equivalents, just to name a few non-limiting examples.

Terminology used herein is for the purpose of illustrating to a person of ordinary skill in the art particular exemplary embodiments only and is not limiting of the claimed invention. Unless otherwise defined, all terms used herein have the same meaning as commonly understood by one of ordinary skill in the art to which this invention pertains, and should not be interpreted as having an excessively comprehensive meaning nor as having an excessively contracted meaning. Nor should dictionary definitions from general subject dictionaries contradict the understanding of any terms as known in the art to persons of ordinary skill.

As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, steps, operations, elements, components, and/or groups thereof.

Furthermore the term “touch” as used herein includes a part of the user body (e.g. hand, finger) and/or a physical object such as stylus pen coming within a predetermined distance of the touch screen without making physical contact.

In addition, the terms “held” and “hold” are to be interpreted broadly and do not require a user's body part (such as a finger or finger) or stylus to remain in contact or near-contact with an object on the screen while a gesture is performed to cause switching of pages, applications, tabs, etc. For examples, a single or double tap of an object can designate the object to be “held”, and then a gesture motion or motions can change pages or applications while the object remains “held” at a designated position. In such a case where the selected object is not being held by a finger or stylus, then a “release” may include a motion or subsequent touch to indicate that the object is released.

Exemplary embodiments of the present invention are now described with reference to the accompanying drawings in detail.

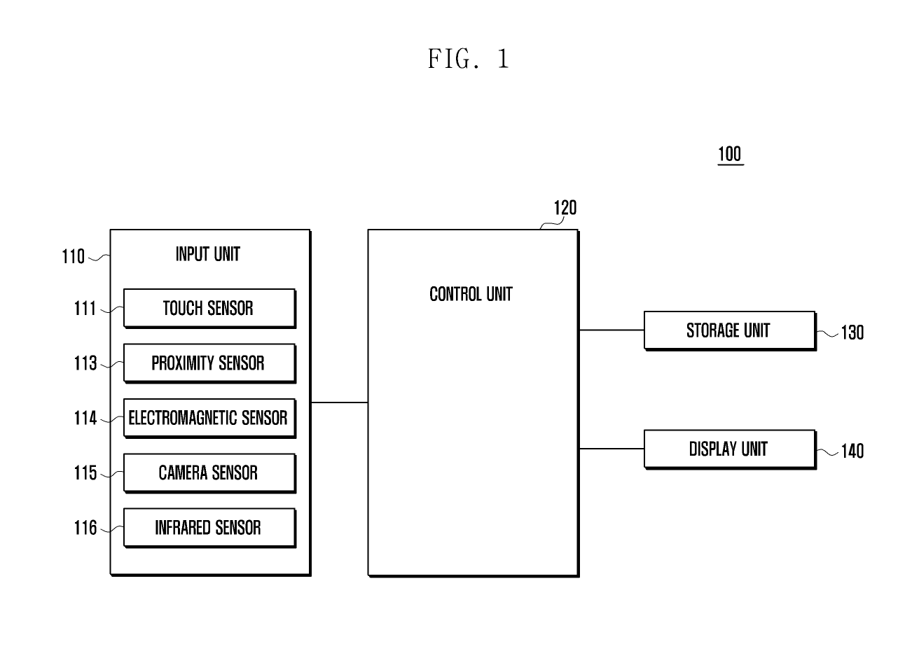

FIG. 1 is a block diagram illustrating a configuration of the terminal according to an exemplary embodiment of the present invention.

As shown in FIG. 1, the terminal 100 preferably includes an input unit 110, a control unit 120, a storage unit 130, and a display unit 140.

The input unit 110 may generate a manipulation in response to a user input. The input unit 110 may preferably including one or more of a touch sensor 111, a proximity sensor, an electromagnetic sensor 113, a camera sensor 114, and an infrared sensor.

The touch sensor 111 detects a touch input made by the user. The touch sensor 111 may be implemented with one of a touch film, a touch sheet, and a touch pad. The touch sensor 111 may detect a touch input and generate a corresponding touch signal that is output to the control unit 120. The control unit 120 can analyze the touch signal to perform a function corresponding thereto. The touch sensor 111 can be implemented to detect the touch input made by the user through the use various input means. For example, the touch input may constitute detecting a part of the user body (e.g. hand) and/or a physical object such as stylus pen and equivalent manipulation button. The touch sensor 111 is can preferably detect the approach of an object within a predetermined range as well as a direct touch according to the implementation.

With continued reference to FIG. 1, the proximity sensor 113 is configured to detect a presence/absence, approach, movement, movement direction, movement speed, and shape of an object using the strength of the electromagnetic field without physical contact. The proximity sensor 113 is preferably implemented with at least one of a transmission-type photosensor, direct reflection-type photosensor, mirror reflection-type photosensor, high-frequency oscillation-type proximity sensor, capacitive proximity sensor, magnetic-type proximity sensor, and infrared proximity sensor.

The electromagnetic sensor 114 detects a touch or approach of an object based on the variation of the strength of the electromagnetic field and can be implemented in the form of an input pad of Electro Magnetic Resonance (EMR) or Electro Magnetic Interference (EMI). The electromagnetic sensor 114 is preferably implemented with a coil inducing magnetic field and detects the approach of an object having a resonance circuit causing energy variation of the magnetic field generated by the electromagnetic sensor 114. The electromagnetic sensor 114 can detect the input by, for example, means of a stylus pen as an object having the resonance circuit. The electromagnetic sensor 114 can also detect the proximity input or hovering made closely around the terminal 100.

The camera sensor 115 converts an image (light) input through a lens to a digital signal by means of Charge Coupled Devices (CCD) or Complementary Metal Oxide Semiconductor (CMOS). The camera sensor 115 is capable of storing the digital signal in the storage unit 130 temporarily or permanently. The camera sensor 115 is capable of locating and tracing a specific point in a recognized image to detect a gesture input.

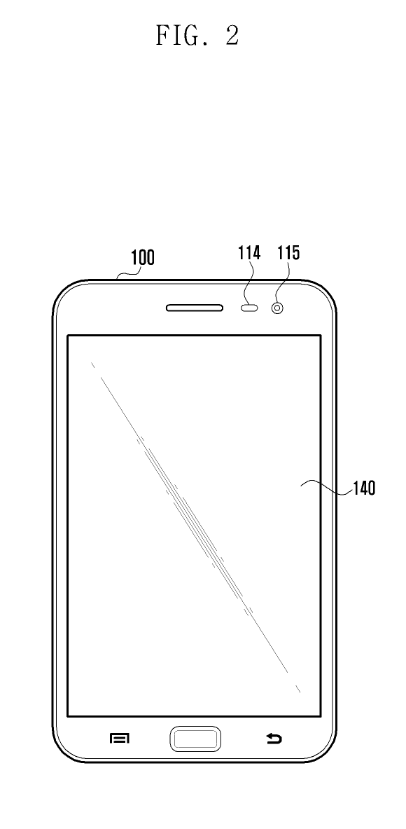

Referring now to FIG. 2, the camera sensor 115 may include combined lenses facing its front and/or rear surface to capture and convert an image through the lenses.

An infrared sensor 116, which is also referred to IR sensor or LED sensor, and can include a light source for emitting the infrared light to an object and a light receiver for receiving the light reflected by the object (e.g. hand) approaching to the terminal 100. The infrared sensor 116 can detect the variation amount of the light received by the light receiver so as to check the movement of and distance from the object. Referring again to FIG. 2, the infrared sensor 116 is arranged at the front and/or rear side of the terminal 100 so as to receive the infrared light emitted from outside of the terminal 100 and/or reflected by a part of the user's body (e.g. hand).

According to an exemplary embodiment of the present invention, the input unit 110 can detect the touch and gesture inputs by the sensor. The input unit 110 may detect the touch and gesture inputs made simultaneously or sequentially and the gesture input subsequent to the ongoing touch input.

The control unit 120, which is comprised of hardware such as a processor or microprocessor configured to control some or all of the overall operations of the terminal with the components. For example, the control unit 120 preferably controls the operations and functions of the terminal 100 according to the input made through the input unit 110.

According to an exemplary embodiment of the present invention, the control unit 120 is configured to control switching based on the detection of touch and gesture inputs of one or more sensors. For example, the switching may comprise any of a page switching, folder switching, tab switching, application switching, and task switching.

Detailed operations of the control unit 120 are now described in more detail hereinafter with reference to the accompanying drawings.

The storage unit 130 is preferably used for storing programs and commands for the terminal 100. The control unit 120 is configured to execute the programs and commands that can be stored in the storage unit 130.

The storage unit 130 may comprise at least one of a flash memory, hard disk, micro multimedia card, card-type memory (e.g. SD or XD memory), Random Access Memory (RAM), Static RAM (SRAM), Read Only Memory (ROM) Electrically Erasable Programmable ROM (EEPROM), Programmable ROM (PROM), magnetic memory, magnetic disc, and optical disk.

According to an exemplary embodiment of the present invention, the storage unit 130 can be utilized to store at least one of an icon, text, image, file, folder, and various forms of content including objects, application, and service functions.

According to an exemplary embodiment of the present invention, the storage unit can store the information about the operation corresponding to the input made through the input unit 110. For example, the storage unit 130 can be used to store the information about the switching operations corresponding to the touch and gesture inputs.

With continued reference FIG. 1, the display unit 140 displays (outputs) certain information processed in the terminal 100. For example, the display unit 150 can display the User Interface (UI) or Graphic User Interface (GUI) related to the voice detection, state recognition, and function control.

The display unit can be implemented with at least one of a Liquid Crystal Display (LCD), Thin Film Transistor LCD (TFT LCD), Organic Light-Emitting Diode (OLED), flexible display, and 3-Dimensional (3D) display.

The display unit 140 forms a touchscreen with the touch sensor as a part of the input unit 110. The touchscreen-enabled display unit 140 can operate as both an input device and an output device.

According to an exemplary embodiment of the present invention, the display unit 140 may preferably display any of icons, texts, images, file lists, and folder lists. The display unit 140 can display at least one of a web browser and contents, website address, and web link.

According to an exemplary embodiment of the present invention, the display unit 140 can display at least one object dynamically according to the switching operation under the control of the control unit 120. For example, the display unit 140 can display at least one object moving in a certain direction on the screen in accordance with a page switching operation.

Although the present description is directed to a terminal depicted in FIG. 1, the terminal may further includes other components than shown, and/or some of the components constituting the terminal may be deleted.

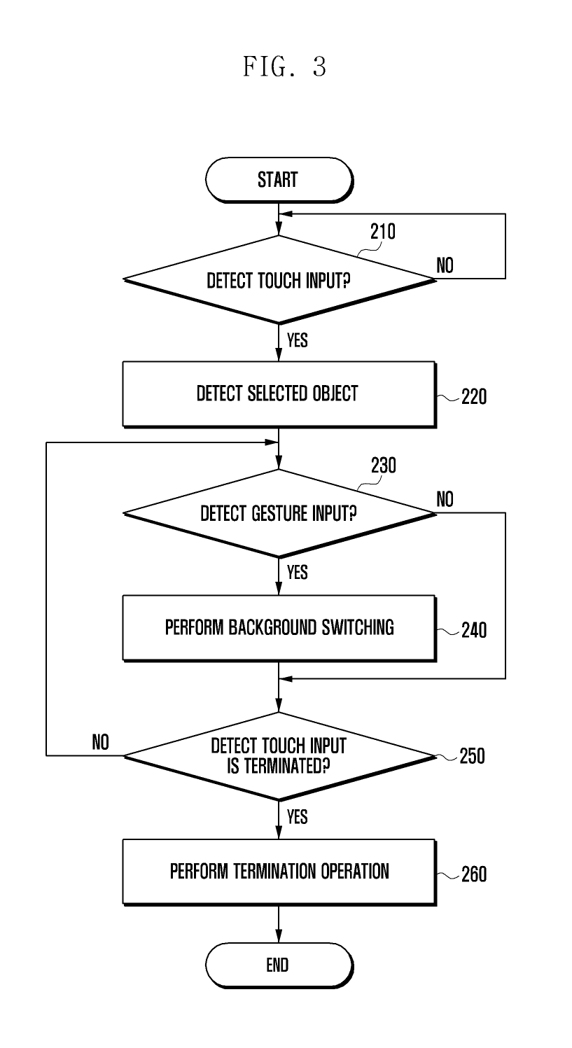

FIG. 3 is a flowchart illustrating the method for controlling the terminal according to an exemplary embodiment of the present invention.

Referring now to FIG. 3, an exemplary method for controlling the terminal according to the presently claimed invention will be discussed herein below.

At step 210, the terminal 100 determines whether or not a touch input is detected.

The terminal 100 can detect more than one touch input made sequentially or simultaneously. According to the implementation, the terminal 100 can be configured to detect different types of touch, such as a proximity-based input or pressure-based input as well as the touch-based input. Therefore the term touch is broad as detecting relatively-close contact by a finger or detectable stylus that can be detected by a proximity sensor can be considered to constitute touch.

If a touch is detected at step 210, then at step 220 the terminal 100 selects an object.

The terminal 100 can be configured to determine the position where on the display the touch is made. For example, the terminal 100 can determine 2-dimensional or 3-dimensional coordinates of the position wherein the touch is made on the screen. Furthermore, the terminal 100 can be configured to check the pressure, duration, and movement of the touch (e.g. drag, variation of the distance between multiple touch points and movement pattern of the touch).

In addition, the terminal 100 can select at least one object corresponding to the touch input. The terminal 100 can be configured to detect at least one object (141) located at the position where the touch input is made. The object can be any of an icon, a text, an image, a file, a folder, a web content, a web address, and a web link. The terminal 100 can display the selected object in the form of activated, enlarged, contracted, or shaded. The terminal 100 can display the selected object as activated, enlarged, shrunk, or shaded according to the time duration for which the touch input has been maintained.

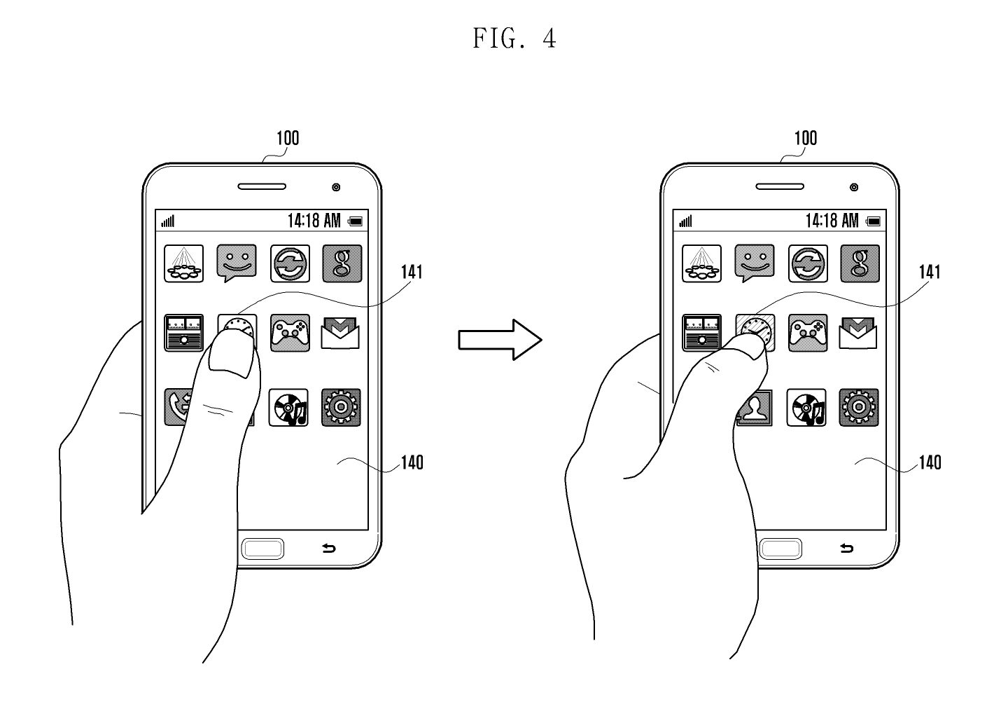

Referring now to the exemplary case of FIG. 4, the UE 100 is operated for selection an icon according to the touch input detected on the idle mode screen. The terminal 100 can display the selected icon (141) in shaded form.

In the case that a touch is made and then moved, the terminal 100 displays the movement of the selected object (141) according to the movement. For example, if a touch is detected and moved in a certain direction, the terminal 100 can display the movement of the selected object in the same direction. The terminal 100 can express/display the moving state of the selected object. For example, the terminal 100 can display the selected object with an additional indicator or a visual effect such as vibration, enlargement, shrink, or shade to express that the object is in the movable state.

Next, referring back to the flowchart of FIG. 3, at step 230 the terminal 100 determines whether a gesture input is detected. The terminal 100 can detect a swipe gesture in a certain direction, a drawing gesture for a certain shape, and a shaping gesture for forming a certain shape. The terminal 100 can detect gesture input direction, speed, shape, and distance from the terminal 100. According to one particular implementation, the terminal 100 can detect an approach input or a pressure input instead of the gesture input.

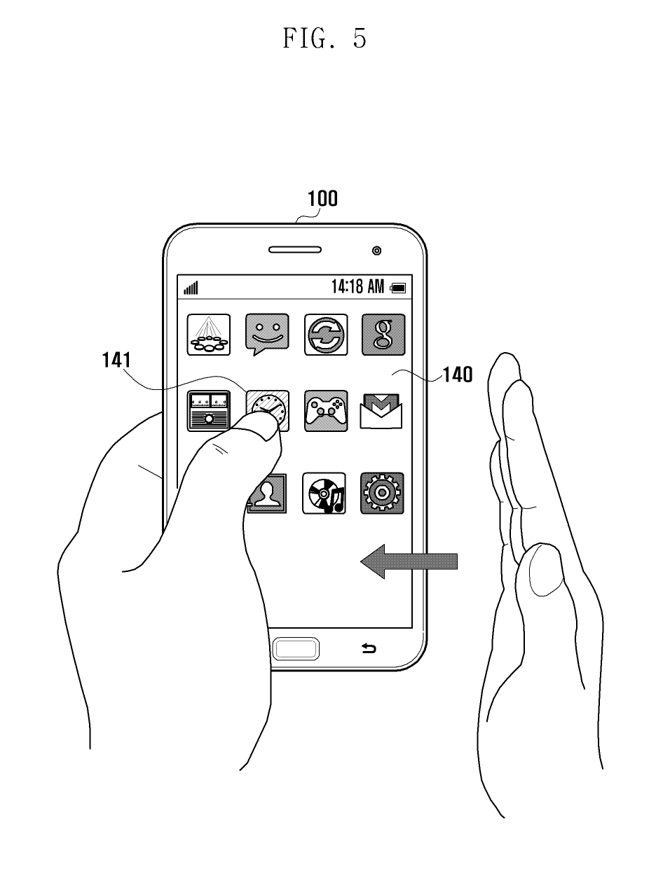

The terminal 100 detects the gesture input in the state where the touch input is maintained. Referring to the exemplary case of FIG. 5, the terminal 100 detects a touch input and a subsequent gesture input made in the state where the touch input is maintained.

If at step 230, the gesture input is detected, then at step 240 the terminal 100 performs a switching operation.

More particularly, the terminal 100 performs the switching operation corresponds to the detected gesture input. The terminal 100 searches for the switching operation matched to the gesture input and, if the switching is retrieved, performing the corresponding switching operation.

The switching operation may comprise any of a page switching operation, a folder switching operation, a tab switching operation, an application switching operation, and a task switching operation, just to name some non-limiting possibilities.

The page switching operation can be performed such that the current page is switched to another page with the exception of the selected object (141). The page switching operation can be performed across the screen of the display on which a plurality of pages, each having at least one object, are turned one-by-one in response to a user's request. For example, the page switching operation can be performed on the idle mode screen, file or folder list screen, selectable menu list screen, document screen, e-book screen, phonebook screen, etc., just to name a few non-limiting possibilities.

The terminal 100 can perform page switching in such that when the current page has a plurality of objects, with the exception of the selected object, the display is switched to another page in the state where the selected object is fixed by the touch input. In other words, the terminal 100 turns the current page with the non-selected objects (which may include the background image) to the next page on the screen in a horizontal or a vertical direction on the screen while the object selected by the touch input remains at a fixed position on the display. At this time, the page turning direction and the number of page turnings can be determined according to the direction of the gesture (e.g. horizontal or vertical) or the shape of the gesture (e.g. shape of the hand expressing a certain number). According to the page switching operation, the objects of the previously displayed page disappear except for the object being held and the objects of the new page appear on the screen. In the case where there are no other pages corresponding to the gesture input, the terminal 100 may skip turning the page or displays a message, icon, or image notifying that there are no other pages.

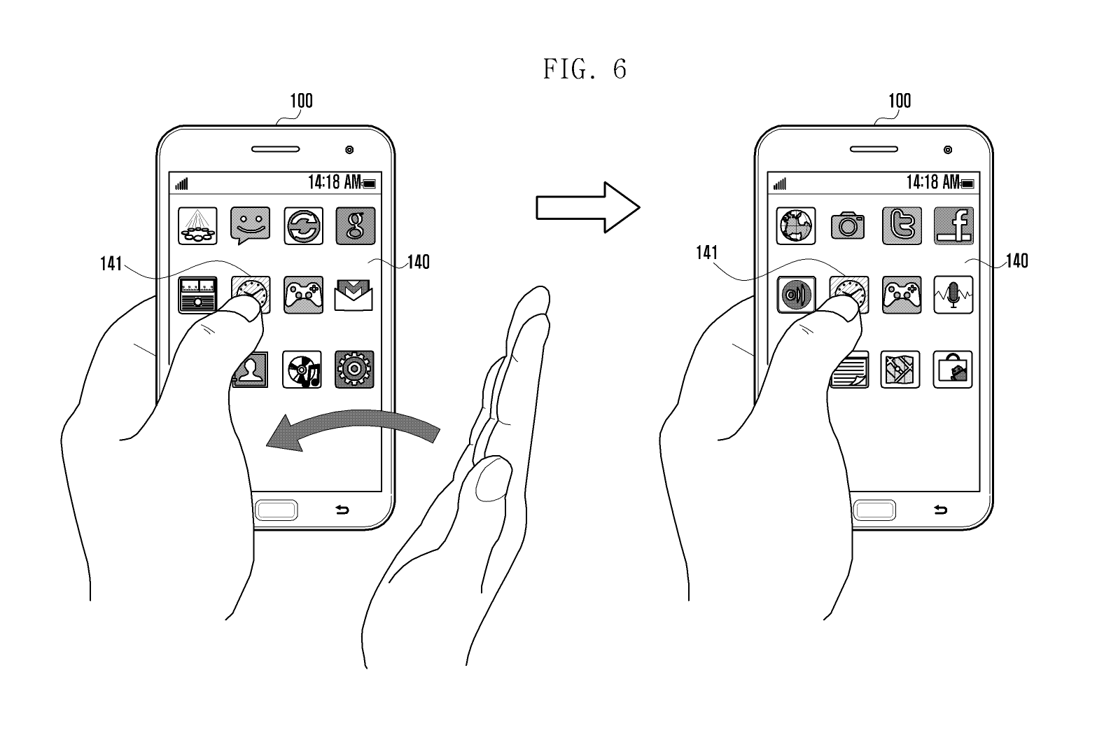

Referring to the exemplary case of FIG. 6, the terminal 100 selects an icon on the idle mode screen in response to a touch input. At this time, the terminal 100 displays the selected icon in the shaded form. The terminal 100 can detect a subsequent gesture input. The gesture input may comprise any detectable motion but in this example comprises a sweeping in the direction from right to left. The terminal 100 can perform the page switching operation while fixing the icon selected in response to the touch input. In other words, the terminal 100 turns the page in the direction corresponding to the direction of the gesture. As the terminal 100 moves the objects to the left, with the exception of the selected object, such that another page appears from the right side.

As shown in FIG. 6, at least one object 141 is being held at a position of the touch input during detection of the gesture input. An artisan should understand and appreciate that the term “during” can constitute a temporal overlap (i.e. an overlapping time period) between the touching of the object and the detection of the gesture input, and it is not an absolute requirement in some embodiments that the object be held while a recognized gesture is made to sweep pages, for example.

The folder switching operation comprises navigating between folders based on the file path of the selected object. The folder switching operation can be performed from among files or folders. For example, the folder switching can be performed between folders including documents, images, pictures, e-books, music files, application execution files or shortcut icons, program execution files or shortcut icons, service execution files or shortcut icons.

For example, one can hold or designate a photo and then with a recognized gesture switch among applications, so that the photo can be inserted in an email, text, Facebook, virtually any kind of communication application that permits transmitting images.

The terminal determines the file path of the selected object held corresponding to the touch input. The terminal 100 can move a folder to a higher or lower level folder along the file path, or a previous or a next folder in a folder list. At this time, a decisions as to whether to move the higher or lower folder level folder or whether to previous on next folder on the same level can be determined according to the direction (horizontal or vertical) of the gesture or the shape of the gesture (e.g. shape of the hand indicating a certain number). According to the folder switching, the objects of the old folder disappear and the objects of the new folder appear on the screen. In the case that there is no other folder corresponding to the gesture input, the terminal 100 skips the folder switching operation or display a message, icon, or image notifying that there is no other folder.

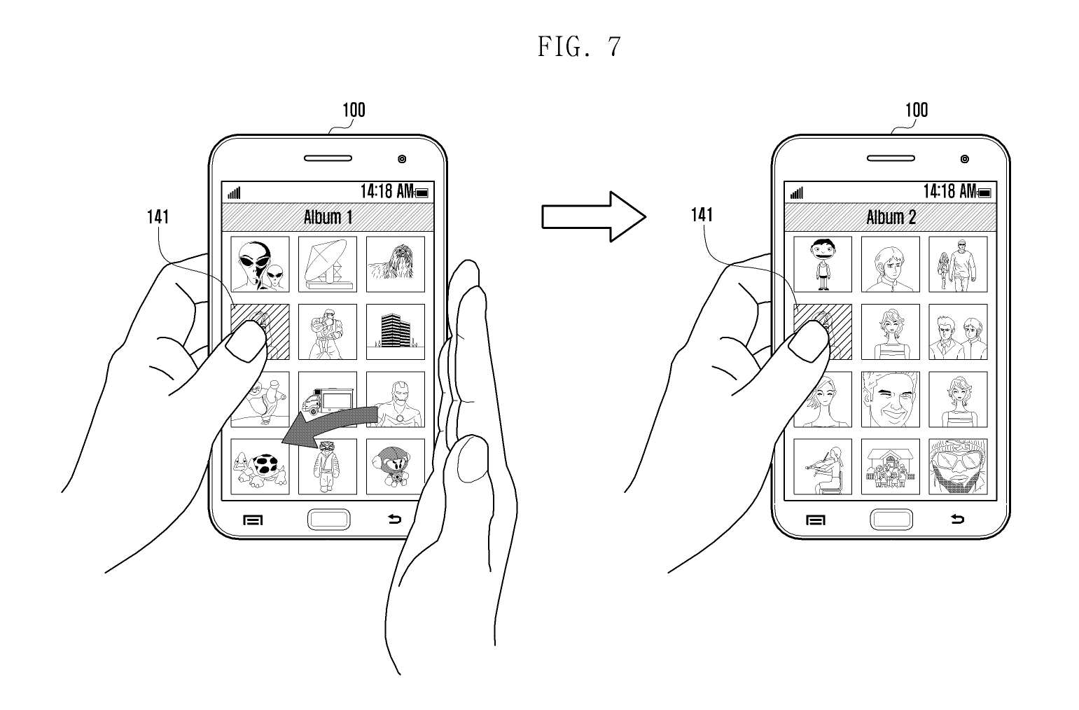

Referring now to the exemplary case of FIG. 7, the terminal 100 is selects a photo in the Album 1 folder corresponding to a touch input. At this time, the terminal 100 displays the selected photo in the shaded form. The terminal 100 can detect a subsequent gesture input. The terminal 100 can also detect the subsequent gesture input while the touch input is held. The gesture input can be, for example, a sweeping gesture input made in a direction from the right to the left. The terminal 100 can perform the folder switching operation while holding the selected photo at the position corresponding to the touch input. In other words, the terminal 100 can move the folder to the direction corresponding to the gesture input. The terminal 100 controls the operation such that the objects included in the Album 1 folder, with the exception of the selected object, from the screen and then a list of the photos included in the next folder, i.e. Album 2 folder, appear on the screen.

The tab switching operation comprises navigating between tabs representing respective applications or programs. The tab switching operation can be performed among tabs of the web browser, menu window, e-book, and/or document viewer applications or programs.

The terminal 100 can hold an object corresponding to a touch input and performing the tap switching operation. In other words, the terminal 100 can move the current tab or at least one object included in the current tab in a horizontal or vertical direction relative to another tab or to be placed in another tab. At this time, the tab switching direction and the number of switching operations can be determined according to the direction (horizontal or vertical) or the shape of the gesture. According to the tab switching operation, the objects of a tab disappear and other objects of another tab appear on the screen. In the case that there are no other tabs corresponding to the gesture input, the terminal 100 skips the tab switching operation and displays a message, icon, or image notifying that there is no target tab.

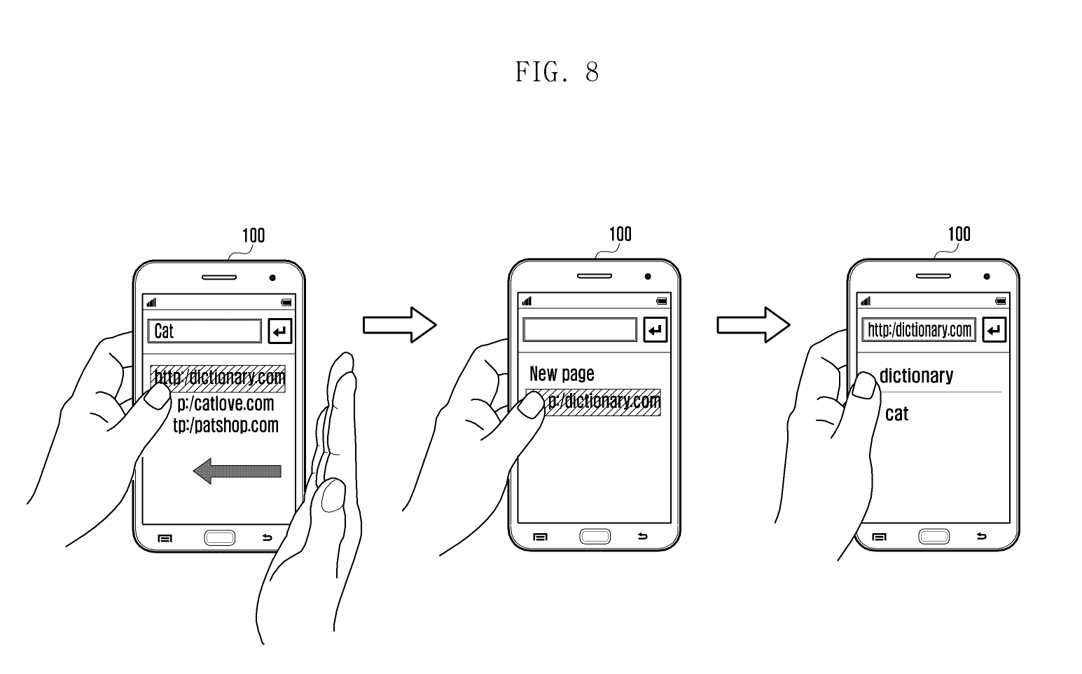

Referring to the exemplary case of FIG. 8, the terminal 100 may select at least one of the objects presented in the current tab of the web browser screen corresponding to a touch input. The object may comprise a web page address, or a text, an image, an icon, or a flash including a link to a certain webpage. At this time, the terminal 100 presents the selected object which changes in color, font, boldness, size, and shade effect. The terminal can detect a gesture input subsequent to the ongoing touch input. The gesture input may comprise a sweeping gesture input made in a direction from left to right. The terminal performs the tab switching operation while the selected object is held at a position of the display according to the touch input. In other words, the terminal moves the tab in the direction corresponding to the gesture input direction. The terminal 100 controls such that the objects of the old tab, with the exception of the selected object, disappear and the objects belonging to another tab on the web browser screen along with the selected object.

The application or task switching operation comprises a switching between execution screens of the application or tasks for moving a selected object. The application or task switching can be performed from among the different applications or tasks predetermined by the user or terminal manufacturer, or from among the applications or tasks that are currently running. The terminal 100 receives and stores a list of the switching-available applications or tasks that are provided by the user or the terminal manufacturer. The terminal 100 identifies the currently running applications or tasks and performs the switching operation based on the preferences, usage frequencies, and operation times of the respective applications or tasks. The application or task can be any of a messaging, SMS, email, memo, and call application or task, just to name some non-limiting possibilities.

According to this aspect of the present invention, the terminal 100 performs the application or task switching operation with the objects except for the selected object on the screen while holding the object selected by the touch input. In other words, the terminal 100 moves the objects (which may include the background image) in a horizontal or vertical direction to display another application or task window on the screen while holding the selected object at the position corresponding to the touch input. At this time, the switching direction and the number of switching times can be determined according to the direction (horizontal or vertical) or shape (e.g. shape of the hand symbolizing a certain number) of the gesture input. According to the application or task switching operation, the application or task and the objects belonged thereto disappear and another application or task and objects belonged thereto appear on the screen. In the case where no other applications or tasks are targeted by the gesture input, the terminal 100 displays a message, icon, or image notifying that there is no target application or task for display.

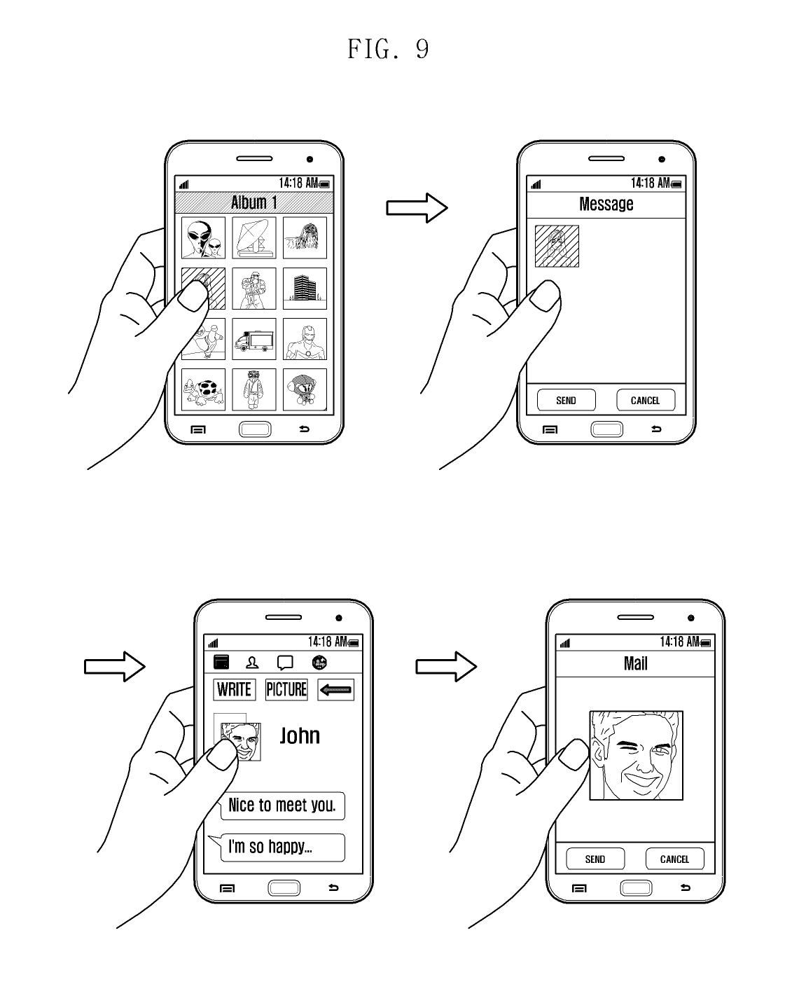

Referring now to the exemplary case of FIG. 9, the terminal 100 selects an image targeted by a touch input. At this time, the terminal processes that the image is presented with an enlarged, shrunk, shaded, or vibrating form. The terminal 100 detects a gesture input. The terminal 100 is capable of the gesture input subsequent to the ongoing touch input. The gesture input can be a sweeping gesture input made in the direction from right to left. The terminal 100 performs the application or task switching operation while holding the selected image at a position of the touch input. The terminal 100 performs the switching operation in the direction of the gesture input. The terminal 100 controls such that the objects with the exception of the selected image move to the left to disappear and then objects belonging to the previous or next task appear on the screen.

The terminal 100 displays the object selected, in association with the application or task switching, in the format optimized for the target application or task. The terminal 100 presents a preview image of the selected object in the format optimized for adding, inserting, pasting, and attaching to the target application or task. The terminal 100 displays the object as enlarged, shrunk, rotated, or changed in extension or resolution, or along with a text, image, or icon indicating addition, insertion, paste, or attachment.

Referring now to the exemplary case of FIG. 9, if an application switching to the text messaging application is performed, the terminal 100 displays the selected image in an attached format in the message input window. At this time, the terminal 100 displaying an icon for warning of the attachment of the image to the text message. If the application switching operation is performed to the email application, the terminal 100 displays the selected image in the attached format within the mail composition window. The terminal 100 displays the image in the format attached to the mail along with the code for image attachment such as html and xml. At this time, the terminal 100 displays at least one of the file name, icon, and file attachment menu for notifying the image file attachment to the email.

Next, the terminal 100 determines at step 250 whether the touch input is released.

After the execution of the switching operation or if no gesture input is detected, the terminal 100 determines whether a touch input is terminated. It is determined that the touch input is terminated when the touch input detects that the user releases the contact of an input device from the touchscreen of the terminal 100.

If the touch input is not terminated, the terminal repeats the switching operation corresponding to the gesture input detection. If the user releases the contact of the input device from the terminal 100, the switching operation of terminal 100 is then terminated.

If the touch input is not terminated, the terminal 100 repeats the switching operation according to the detection of gesture input.

Otherwise, if the touch input is terminated, the terminal 100 terminates the procedure at step 260.

The termination operations may comprise any of aligning the selected object at a position targeted by the touch input, executing the link of the selected object on the tab of the web browser, and pasting the object onto the application or task execution screen.

In the exemplary embodiment of FIG. 6, if the touch input is terminated, the terminal 100 arranges the selected icon at the position where the touch has been released. In order to place the icon at the position targeted by the touch input, the terminal can target moving or rearranging the icons on the page. The terminal 100 is also can store the information about the rearranged page. In the case where an icon, or other item is designated by a tap or a contactless pointing, for example, that is recognized by the touch screen as designating the particular icon or other item to remain stationary while a gesture such as a sweeping motion moves through applications, screens, etc., since such an icon or item in this example is not being held, another recognized act, such as a double tap, or another tap, or a motion, can signal that the icon or other item is no longer designated.

In the exemplary embodiment shown in FIG. 7, if the touch input is terminated, the terminal 100 arranges the page by placing the selected image at the position where the touch has been released. The terminal 100 rearranges the list of images in the folder navigated to insert the image. The terminal 100 moves and stores the selected image in the corresponding folder or address and updating the information on the folder or image.

In the exemplary embodiment of FIG. 8, if the touch input is terminated, the terminal 100 adds, inserts, pastes, or attaches the selected object onto the execution screen of the application, or task where the touch input has been terminated. The terminal 100 attaches the selected image to a text message and inserts the selected image to the message composition window. The terminal 100 is also executes a text composition mode and attaches the selected image to the text composition window to post the selected image on an SNS site.

The configuration of the terminal 100 is not limited to the above-described exemplary embodiments but can be modified to perform various operations in response to the detection of the termination of the touch input without departing from the range of the present invention.

The touch and gesture input-based control method and terminal therefore according to the present invention facilitates control of the operations of the terminal with the combination of the intuitive touch and gesture inputs made on the improved input interface.

The above-described methods according to the present invention can be implemented in hardware, firmware or as software or computer code loaded into hardware such as a processor or microprocessor and executed, the machine executable code being stored on a recording medium such as a CD ROM, an RAM, a floppy disk, a hard disk, or a magneto-optical disk or computer code downloaded over a network originally stored on a remote recording medium or a non-transitory machine readable medium and to be stored on a local recording non-transitory medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, thumbnail, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

Although exemplary embodiments of the present invention have been described in detail hereinabove with specific terminology, this is for the purpose of describing particular exemplary embodiments only and not intended to be limiting of the invention. While particular exemplary embodiments of the present invention have been illustrated and described, it would be obvious to those skilled in the art that various other changes and modifications can be made without departing from the spirit and scope of the invention.

What is claimed is:

1. A method for controlling a terminal, comprising:
detecting a touch input on a touch screen display;
detecting a selection of at least one object of a plurality of objects corresponding to the touch input on the touchscreen display;
detecting a gesture input by a sensor in a state wherein the touch input of the at least one object is held on the touchscreen for at least an overlapping time period when the gesture is detected; and
performing switching of a display of one or more of the plurality of objects other than the at least one object which is held on the touchscreen display and corresponding to the gesture input in a state where the object is held at a position of the touch input.

2. The method of claim 1, wherein the at least one object held on the touchscreen display comprises at least one of an icon, a text, an image, a file, a folder, a content of a web browser, a web address, and a web link.

3. The method of claim 1, wherein detecting a selection of the at least object held on the touchscreen display comprises presenting the object in one of activated, enlarged, shrunk, shaded or highlighted states.

4. The method of claim 1, wherein detecting a gesture input comprises sensing the gesture input in a state wherein the touch input of the at least one object held on the touchscreen display is maintained on the touchscreen display for at least a partial overlapping time period with detection of the gesture.

5. The method of claim 1, wherein the switching of objects being displayed while the at least one object is being held comprises at least one of page switching, folder switching, tab switching, application switching, and task switching.

6. The method of claim 1, wherein performing switching comprises:
detecting the at least one object corresponds to the touch input; and
switching from among a display of plurality pages having the at least one object in the state of being held on the touchscreen display.

7. The method of claim 1, wherein performing switching comprises:
detecting the at least one selected object corresponding to the touch input; and
switching a display from among higher and lower folders along a file path or between folders in a folder list while displaying the selected object.

8. The method of claim 1, wherein performing comprises:
detecting the at least one object is being held on the touchscreen display corresponding to the touch input; and
switching by the control unit a display from among a plurality of tabs provided by a web browser.

9. The method of claim 1, wherein performing switching comprises:
detecting the at least one object being held on the touchscreen display corresponding to the touch input; and
switching by the control unit a display from among applications or tasks listed in a predetermined list or a list of currently running applications or tasks.

10. The method of claim 9, wherein switching from among applications or tasks comprises displaying the at least one object being held on the touchscreen display and arranged in a format that is optimal for the application or task switched to from the predetermined list or the list of currently running applications or tasks.

11. The method of claim 1, further comprising:
detecting by the touch sensor a release of the touch input of the selected object being held on the touchscreen display; and
performing by the control unit an operation corresponding to the release of the touch input for the selected object.

12. The method of claim 11, wherein the operation corresponding to the release of the touch input comprises at least performing one of arranging the object at a position corresponding to the release of the touch input, executing a link of the selected object in a tab of the web browser, and pasting the object on an execution screen of the application or task.

13. The method of claim 11, wherein the object comprises at least one image that is pasted on or attached to a text message or email message.

14. The method of claim 11, wherein the object comprises at least one image that is pasted on or attached to a Social Networking application.

15. The method of claim 1, wherein the gesture includes shape of a hand.

16. A terminal comprising:
an input unit which detects touch and gesture inputs;
a control unit which detects selection of at least one object of a plurality of objects corresponding to the touch input and performs switching of a display of one or more of the plurality of objects other than the at least one object, corresponding to the gesture input, in a state where the selected object is held at a position of the touch input of the input unit; and
a display unit which displays a screen under the control of the control unit.

17. The terminal of claim 16, wherein the switching performed is one of page switching, folder switching, tab switching, application switching, and task switching.

18. The terminal of claim 16, wherein the control unit holds the selected object corresponding to the touch input and switches from among a plurality pages having the selected object held on the screen.

19. The terminal of claim 16, wherein the control unit controls display of the selected object on the touchscreen display corresponding to the touch input and switches from among higher and lower folders along a file path or between folders in a folder list.

20. The terminal of claim 16, wherein the control unit holds the selected object on the touchscreen display and corresponding to the touch input and from switches among a plurality of tabs provided by a web browser.

21. The terminal of claim 16, wherein the control unit holds the selected object on the touchscreen display corresponding to the touch input and switches from among applications or tasks listed in a predetermined list or a list of currently running applications or tasks.

22. The terminal of claim 21, wherein the control unit controls the display unit to display the selected object on the touchscreen display in a format arranged optimally for a current application or task in which the selected object is displayed.

23. The terminal of claim 17, wherein the input unit detects a release of the touch input, and the control unit performs one of arranging the selected object at a position corresponding to the release of the touch input, executing a link of the selected object in a tab of the web browser, and pasting the selected object on an execution screen of the application or task.

24. The terminal of claim 23, wherein the selected object comprises at least one image that is pasted on or attached to a text message or email message.

25. The method of claim 23, wherein the selected object comprises at least one image that is pasted on or attached to a Social Networking application.

26. The method of claim 1, wherein the gesture includes shape of a hand.
